(19) United States
(12) Patent Application Publication
(10) Pub. No.: US 2013/0024468 A1
(43) Pub. Date: Jan. 24, 2013

(54) FRESH FOOD NUTRITIONAL MANAGEMENT SYSTEM

(71) Applicant: Susan C. Kocsis, Windsor, CA (US)

(72) Inventor: Susan C. Kocsis, Windsor, CA (US)

(73) Assignee: LUCKY STAR INNOVATIONS, LLC, Windsor, CA (US)

(21) Appl. No.: 13/555,520

(22) Filed: Jul. 23, 2012

Related U.S. Application Data
(60) Provisional application No. 61/510,935, filed on Jul. 22, 2011.

(51) Int. Cl. B65D 21/08; B65D 53/06; G06F 17/30; B65D 43/04

(52) U.S. Cl. 707/758; 220/23.88; 220/806; 707/E17.009

(57) ABSTRACT

A food storage and nutrition management system including a primary container having which defines a volume for storing a plurality of secondary containers smaller than the primary container. The secondary containers store food items and include a bottom side and an upper rim and are sized and configured such that when placed in the primary container, the upper rims of the secondary containers are substantially co-planar. A container lid sealing closes the primary container and includes a resilient gasket on its underside. Lids are also provided for the secondary containers when used outside the primary container. The gasket is configured to engage the upper rims of the secondary containers regardless of the configuration in which the secondary containers are placed in the primary container. The gasket partially compresses at the upper rims of the secondary containers to form a substantially air tight seal between each of the secondary containers.

### CROSS REFERENCES TO RELATED APPLICATIONS

The present application claims the benefit of U.S. Provisional Patent Application Ser. No. 61/510,935 filed Jul. 22, 2011 (Jul. 22, 2011).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates generally to systems for promoting healthful eating habits, meal planning, food shopping, and the preparation, storage, preservation, and serving of fresh food, and more specifically, the present invention relates to a food container system for enhancing food freshness, optimizing the appetite-appeal, preserving nutritional value, facilitating easy transport of recently prepared food, reducing food spoilage and waste, all in cooperation with software using current data management and digital communications technology that encourages good diet, intelligent food shopping and selection, and efficient food management.

2. Background Discussion

The present invention was originally inspired by the concept of the salad bar, the convenience of commercial kitchen preparation tables, and ultimately by the broader need in society for individuals to eat a healthier diet and to reduce food waste.

Ongoing research undertaken by the U.S. Department of Agriculture and the Department of Health and Human Services underscores the role of food and nutrition in the health and well-being of American society. In particular, reducing the incidence of overweight or obese individuals and the health problems and disease associated with obesity and poor nutrition, such as heart disease, stroke, and type II diabetes, and improving the nutrition of the American diet are cornerstones of public health, nutrition policy, and education.

In support of dietary guidelines for the public, the present invention provides a tool that can be used by individuals, organizations, and institutions to overcome a set of impediments that exist in modern society and that make it difficult to “eat right” consistently. In particular, the present invention provides a corrective to: (1) the general lack of knowledge about diet, food, and nutrition among the public, (2) the unwillingness of individuals to take the time to prepare nourishing food, and (3) the lack of a system that optimizes space in a home refrigerator to reduce spoilage and waste of foods in forgotten or hidden containers.

The present invention can be understood as a fresh food nutritional management system which, (1) provides a food preparation, preservation and serving device based on culinary best practices, and (2) makes use of current communications and computing technology to deliver dietary knowledge and meal planning tools. The nutrition management system of the present invention makes the consumption of fresh food as simple as possible, and makes compliance with USDA dietary guidelines a relatively easy achievement. Additionally, it provides knowledge about how to maintain appetite appeal and minimize waste by storing foods to preserve their nutritional benefit. The system encourages the consumption of healthful foods to promote individual heath, reduce the risk of chronic disease and obesity.

Food has become a problem for Westerners generally, and particularly problematic for Americans, because American farms have worked now for decades under programs subsidized not only to ensure a flourishing agricultural economy, but to produce the maximum amount of calories using the minimum amount of energy and money. Under such programs corn has become a nearly “hegemonic” crop, and maximum economic use of this easily grown crop gave rise to its transformation into high fructose corn syrup and other processed foods and additives for calorie rich and nutritionally poor food products. In promoting such foods under a singular compelling profit motive, the food industry in America, and its sophisticated marketing arms, has shaped tastes and created an almost insatiable appetite for cheaply manufactured, highly processed, nutritionally empty foods, ironically containing a large number of calories and having high glycemic indices, such that consumer never really feel satisfied with the foods they eat, at least not for long. There has been a remarkable amount of tinkering with food done in the name of food science, and corporate wide scale food production that has resulted in a cornucopia of packaged processed foods. And now high proportions of Americans either eat the wrong foods or simply eat too much.

The present invention introduces a systems approach to food and diet management and eliminates the impediments that prevent people from regularly eating a nourishing diet. It makes it easy to shop for, prepare, and preserve a range of healthy foods for making salads, cooking nutritious meals, and raw food consumption.

### BRIEF SUMMARY OF THE INVENTION

The present invention addresses the above-described problems by encouraging and facilitating good eating habits and by motivating healthy food preparation by making it as easy as possible. The system encourages the consumption of a range of fresh foods across each food group.

In its most essential aspect, the system is a food storage and nutrition management system including a primary container having an open top, a bottom, and sides which define a volume for storing a plurality of secondary containers smaller than the primary container. The secondary containers store food items and include a bottom side and an upper rim; they are sized and configured such that when placed in the primary container, the upper rims of the secondary containers are substantially co-planar. A container lid sealing closes the primary container and includes a resilient gasket on its underside. The gasket is configured to engage the upper rims of the secondary containers regardless of the configuration in which the secondary containers are placed in the primary container. The gasket partially compresses at the upper rims of the secondary containers to form a substantially air tight seal between each of the secondary containers.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1A is an upper perspective view of a first preferred embodiment of the present invention showing a primary container with a plurality of nested secondary containers and a lid (in this instance, with the lid removed);

FIG. 1B is an exploded view thereof;

FIG. 2 is an upper plan view showing the silicone gasket employed in the lid of the first preferred embodiment;

FIG. 3A is cross-sectional side view in elevation as taken along Section Lines 3A-3A of FIG. 1A;

FIG. 3B is the same view showing the lid placed on the primary container;

FIG. 4 is an upper perspective view showing a second preferred embodiment for the lid employed in the present invention;

FIG. 5A is a cross-sectional side view in elevation showing the system using the lid as shown in FIG. 4, this view showing the lid poised for placement on the primary container;

FIG. 5B is the same view showing the lid placed and sealed on the primary container;

FIG. 6 is a detailed cross-sectional side view in elevation showing a portion of the lid of the second preferred embodiment as taken along Section Line 6 of FIG. 5A.

### DETAILED DESCRIPTION OF THE INVENTION

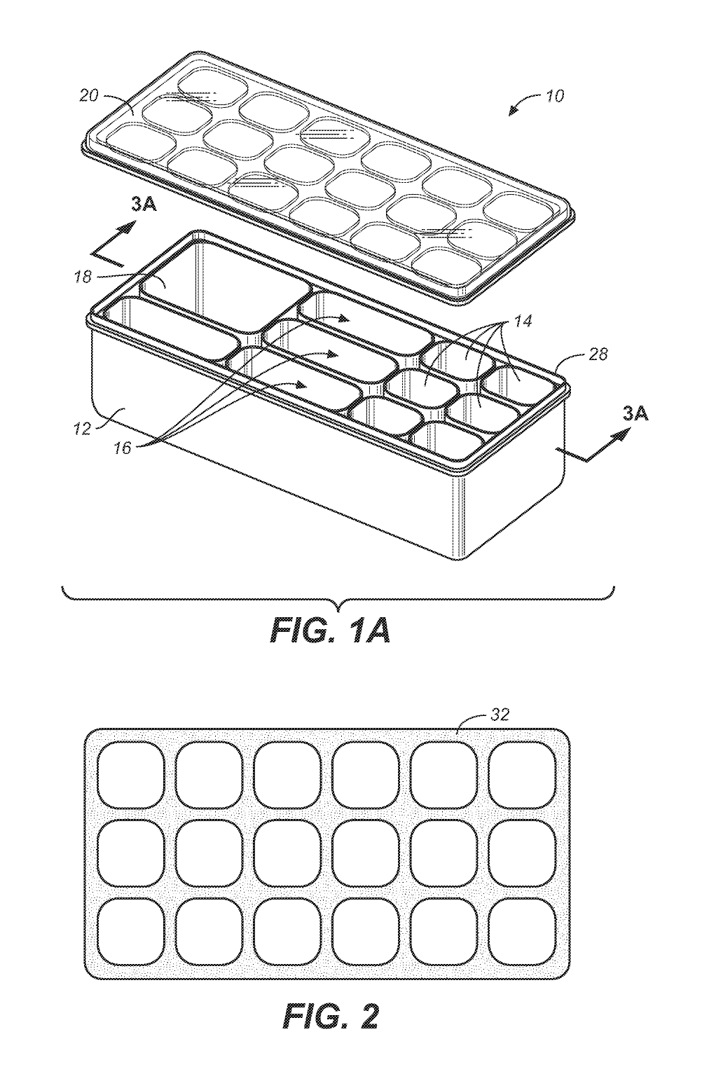

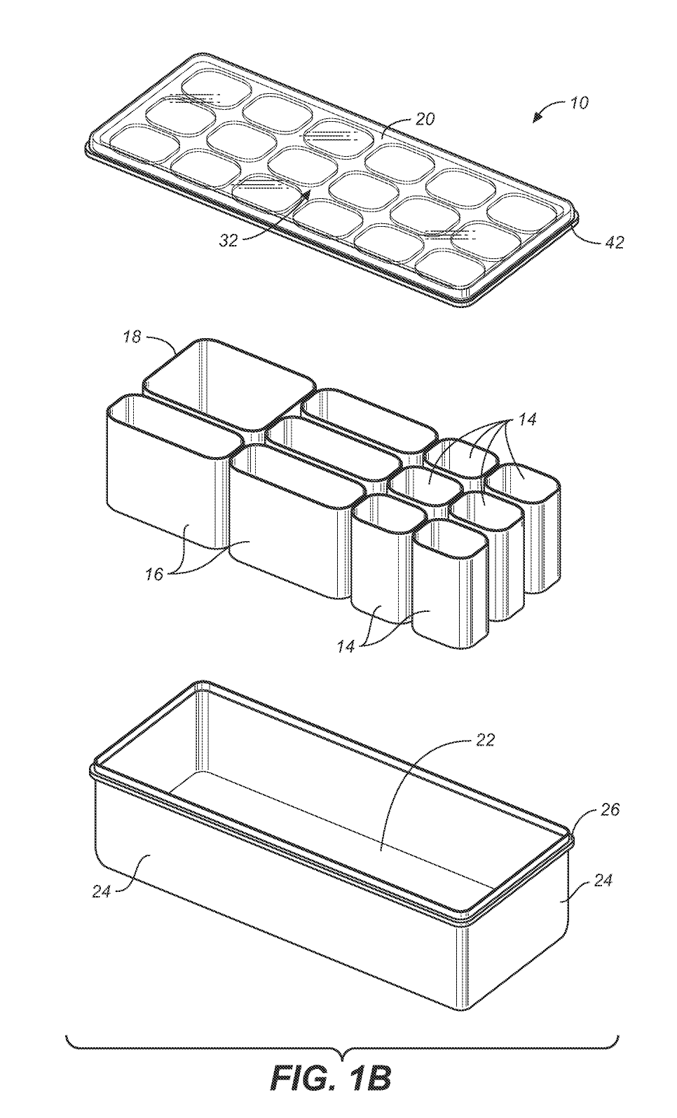

Referring first to FIGS. 1 through 3B, wherein like reference numerals refer to like components in the various views, there is illustrated therein a first preferred embodiment of a new and improved fresh food nutritional management system, generally denominated 10 herein. These views collectively show that in its most essential aspect, the present invention includes a primary container (or tray) 12 for containing a plurality of variously sized secondary containers (or inserts) that function as food receptacles. For simplicity in the consideration of the invention, the secondary containers may include a small size 14, a medium size 16, and a large size 18, and have a geometry that enables them to be arranged in a layout such that the containers are securely nested within the primary container. A lid 20 provides a generally airtight seal to ensure product freshness over time. The number and size of the inserts is potentially unlimited, though for practical purposes it has been found that a primary container suitable sized for non-commercial use and for storage in a residential refrigerator is adapted to hold inserts of up to seven different sizes. The principles of the inventive system, however, are unaltered by the particular size of the primary container (the tray) or the particular number of secondary containers used as inserts. When removed from the primary container, the secondary containers may be provided with their own suitable sized lids for sealing the respective secondary containers individually outside the primary container.

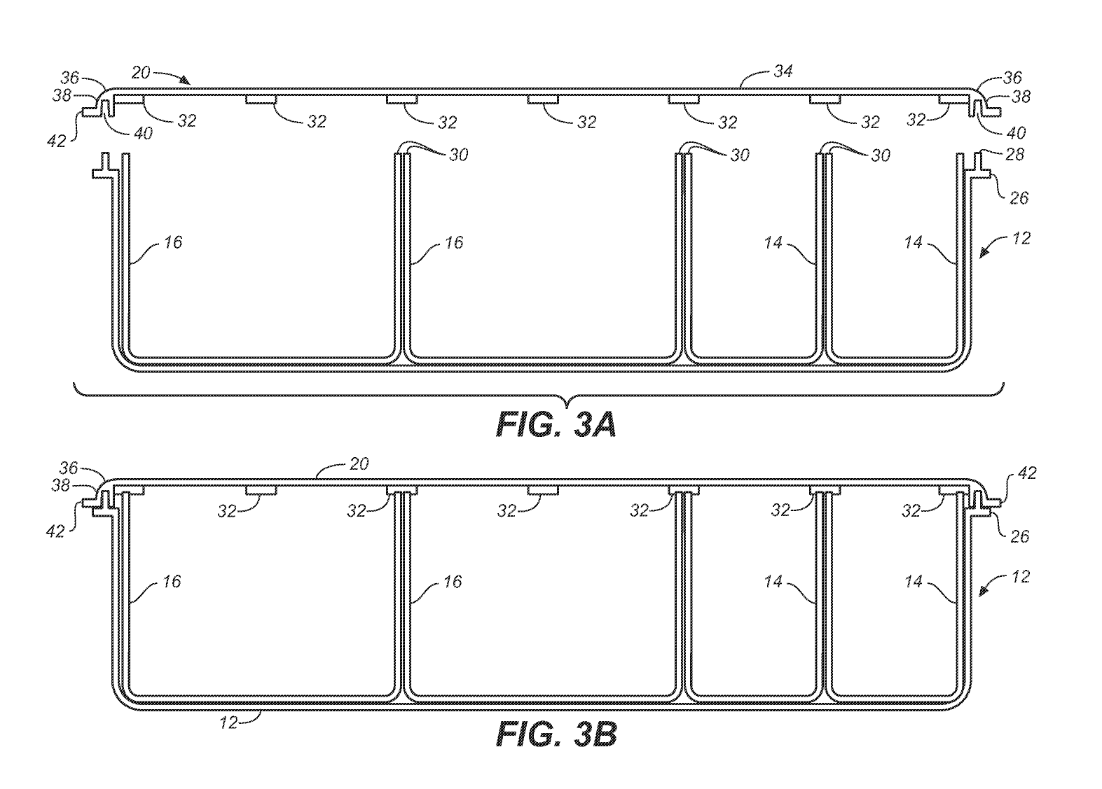

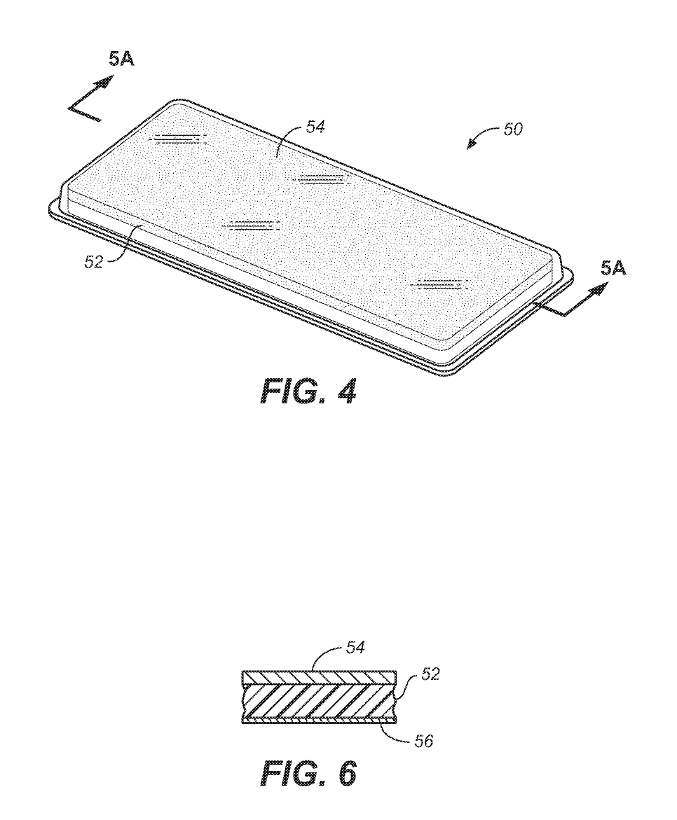

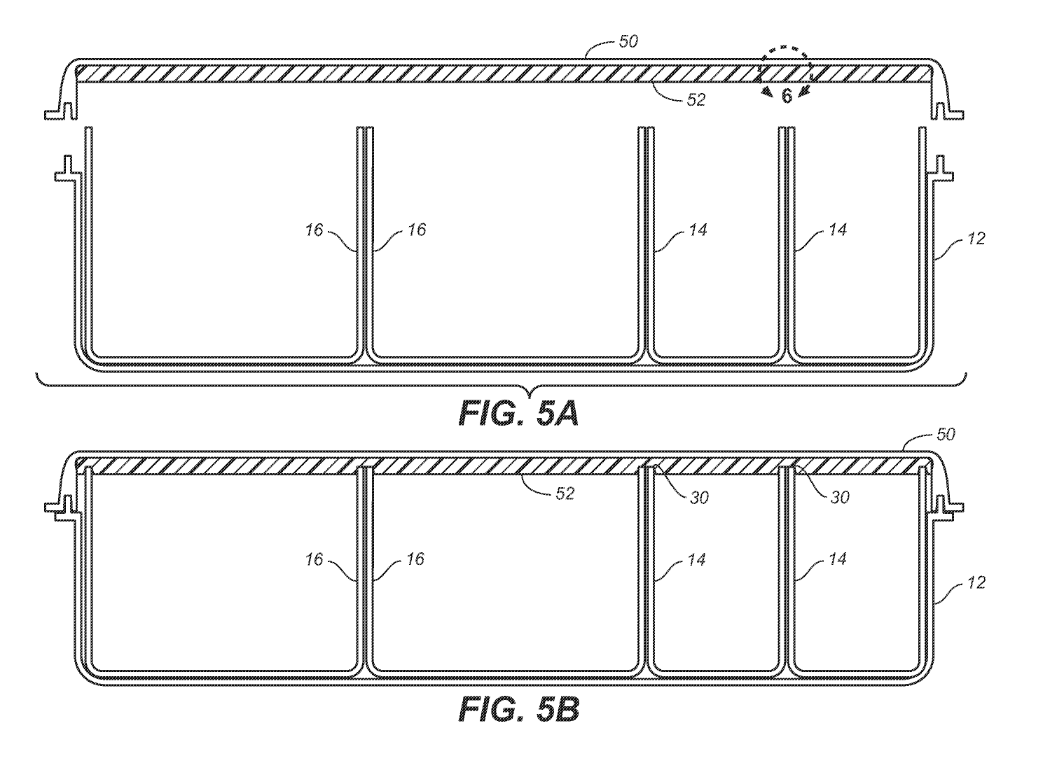

The primary container has an open top 21, a bottom 22, and sides 24, which define a volume 25 for containing the smaller secondary containers. An outwardly extending flange 26 with an upwardly extending rim 28 circumscribe the top portion of the sides. The secondary containers, as noted, are sized such that when combined in any of a number of suitable combinations nest securely within the sides of the primary container, and each of the secondary containers include a height such that when the respective bottom sides 29 of the secondary containers are placed on the bottom 22 of the primary container, the respective upper rims 30 engage a resilient and reusable silicone gasket 32 disposed on the underside of the top panel 34 of the lid (said gasket described more fully, below) [see esp. FIGS. 3A and 3B]. The gasket may be either permanently affixed or removable.

The top panel 34 curves or angles at its edges 36 into a downwardly depending perimeter wall 38 having a slot 40 for sealable engagement with the upwardly extending rim 28 of the primary container. An outwardly extending flange 42 surrounds the perimeter wall and provides structure for users to manipulate the lid when placing it on or removing it from the primary container, as is well known in the art.

Referring to FIG. 2, it will be seen that the gasket employed in the first preferred embodiment is configured as a grid having substantially identical square open cells 33 with rounded corners. The size of the cells is slightly smaller than the area defined by the periphery of the upper rim of the smallest secondary container. Accordingly, and as can best be seen in reference to FIGS. 3A and 3B, when placed in the primary container, the upper rims 30 of the secondary containers are generally coplanar, such that the resilient and reusable silicone freshness gasket 32 engages the upper rims 30 to create a substantially airtight seal for each of the secondary containers individually. Further, this sealing engagement also securely captures and holds the secondary containers within the primary container. In this way, the gasket prevents food products contained within the secondary containers from sloshing and spilling over the upper edges of the secondary containers, so that neighboring secondary containers within the primary container are not contaminated by food(s) from other nearby containers. Further, the gasket prevents not just the physical migration of foods within the assembly, but also the migration of odor molecules, such that strong odors from a food or foods in one or more containers (e.g., onions, garlic, kimchi, to name just a few) are kept from contaminating nearby foods. The gasket also helps keep flavors fresh.

In another preferred embodiment, the primary container may include a pocket, drawer, or lower container, either integrally formed in or disposed closely under the bottom of the container, or which may be connected with snap fit elements so as to provide a space for positioning ice packs or gel packs. This provides a cooling base upon which the container assembly is disposed for use as a cooler when transport and prolonger cool temperatures are required for the entire assembly.

In the preferred embodiment, the primary container may be sized variously in increments ranging from approximately 9″×9″ to 9″×18,″ while the secondary (food) containers that insert inside the primary container are sized in ranges from 1½″×3″ to 3″×3,″ to 3″×6,″ to 6″×6″, and possibly up to 3″×9″, 6″×9″, and 9″×9″, the particular sizes and combinations of sizes selected for use with a primary container sized to meet the anticipated needs of the user. When the gasket is configured in a grid configuration, the secondary containers are sized such that the shape and area described by the periphery of the upper rims of the medium and large secondary containers are even multiples of the shape and size of the shape and area described by the periphery of the upper rim of the small secondary container. For instance, medium and large(r) secondary containers are preferably two, three, four, or more times the size of the small container. The bottoms of the secondary containers are flat, and the sides are very slightly sloped for ease in stacking the inserts when stored. Thus, as with the area defined by the periphery of the upper rims of the secondary containers, the volumes of the medium and large containers are approximately a factor of 1 or 2 larger than the smallest container. The grid shaped gasket 32 thus engages the upper edges of the secondary container regardless of the arrangement of the secondary containers within the primary container (assuming, of course, that the secondary containers are neither inverted nor laid on side). It will be appreciated, however, that any of a number of suitable sizes and size combinations may be employed to meet the inventive feature of nested secondary containers capable of various layouts when contained within the primary container. Additionally, trays can be ornamental or decorative, inasmuch as the system can be used as a serving system.

Containers and inserts are made from lightweight, clear or colored plastic, glass, or unbreakable polycarbonate. The secondary containers are easily removed and reconfigured to suit the food being prepared. Trays can be configured to snap together when stacked. Preferably, the plastics used in fabrication are microwave, freezer, and dishwasher safe, and are made without BPAs or phthalates, and while disposal of the secondary containers is not contemplated, they may be made with a plastic additive to enhance biodegradability, such as the additive for modifying PET plastics, as made by ENSO Plastics of Mesa, Ariz., or they may be made from Eastar bio ultra copolymer from Eastman Chemical Company of Kingsport, Tenn.

In a second preferred embodiment, the lid 50 of the inventive system is fitted not with a silicone gasket in a grid configuration, but instead with a soft resilient and compressible foam panel 52, also applied to the underside of the top panel 54 of the lid 50. An impermeable sheet 56 of semi-resilient plastic manufactured using PVC, PET, ABS, PS, HIPS, or comparable materials is disposed on the bottom side of the resilient and compressible foam panel. This embodiment performs the same function as the grid configured gasket of the first preferred embodiment.

In the food management system of the present invention, foods to be prepared are arranged on a cutting board or kitchen surface, chopped or sliced in whatever way suits the meals to be prepared, and then placed inside the various nesting secondary containers for later use in cooking or meal preparation. Once each food has been prepared and placed within a nested secondary container, the lid is snapped onto the primary container so that the freshness gasket contacts the rim of each container and seals each compartment from the others. The fresh food storage and preservation assembly can then be placed in a refrigerator for use at meal time, or transported with s removable cooling apparatus to another location.

Different trays can be prepared for different eating occasions, for example one could be for a salad in the evening, another could be for a picnic or a tail-gate party at an athletic event, and another could contain fresh fruits and vegetables for snacking during the day. Or, different foods can be prepared to address selected activities and their respective set-ups such as for a salad bar˜omelet fillings, sandwiches, pizza toppings, or for making sundaes.

In developing the present invention, the inventor searched retail stores, catalogues, and the internet for a “systems approach” to food storage, preservation, and consumption that would encourage and support healthy eating. Her search was largely unsuccessful. Despite the existence of many types and sizes of individual food storage and shelving containers, there was no comprehensive system that provided individually sealable yet closely located food receptacles in the style of a salad bar or commercial kitchen preparation table. Additionally, research did not reveal any eating systems that combined digital technology with a device or apparatus designed to deliver fresh food management and to meet modern dietary guidelines.

For that reason, the inventor conceived and engineered a food management system that exploited digital communication and data management technology as well as a highly versatile, flexible system of containers, inserts, and lids to store a volume of foods in a limited amount of space, while also preventing foods, their liquids, or their scents from contaminating nearby or adjacent foods. After much experimentation, the inventor fabricated a working model of the apparatus, and tested a number of units to develop a fresh food storage and preservation assembly that contains and seals multiple fresh food stuffs.

When used in connection with software that exploits contemporary data management and communications technology, the fresh food nutritional management system consists of a shopping system embodied in a smart phone app, along with the above-described fresh food storage and preservation device.

The practice of the invention involves a simple smart phone shopping app which allows meal planning based upon food groups and nutritional information, the creation of a shopping list, and a data base of dietary and nutritional information for commonly purchased foods and beverages. This provides the education and the planning tools necessary to intelligently plan meals and make shopping lists.

The shopping app accesses information on the foods most frequently purchased in the grocery store by the general public, as well as the particular foods that the user personally buys and regularly inputs. It learns the user's preferences and anticipates entries, tracks dietary needs, invokes recommended information from a nutrition data base, and reports dietary needs and performance to the user.

Thus, for example, the user can enter foods by selecting foods of interest from a comprehensive menu of food items stored in a database and accessed using the application. These foods may be organized by category (e.g., staples, breakfast foods, dairy, fruit, etc.) and/or may be searched by brand, alphabetically by generic name, or using any other suitable search function. Additionally or alternatively, food items may be entered by a single smart phone to photograph a bar code (on the product or shelf), label, or other identifying information. If appropriate relationships can be established, food item information may be downloaded from grocery store loyalty card databases, on-line recipes or other third party sources. These food items may be collected into user-selected groups based on recipes, staples, or the like to facilitate generation of shopping lists and application of nutrition tools as described below.

Using these food items, the application can perform a number of functions. For example, the application can be used to generate a shopping list which may be displayed or printed. This process is facilitated by the lists of frequently purchased foods and recipes. Moreover, items may be automatically added to the shopping list by scanning or photographing a bar code or the like when a food container is emptied (or the user otherwise anticipates a need for replenishing the item). The application may also learn a frequency of purchase for some items and make shopping list suggestions. The shopping list may be ordered based on grocery store location found by a GPS-based radial search in a connected device or in any other convenient manner. Finally, healthful alternatives may be suggested for shopping list items.

The application may also provide nutritional information related to food items. Such information may include food groups, calories per serving, percentage of recommended daily allowance per serving for various nutrients, vegan compliancy, gluten-free, allergen information, fair trade compliance, organic certifications, source geographic information, or any other information of interest regarding the food items. The information may be provided on an item-by-item basis or on a grouped basis, e.g., in the case of a recipe.

In addition, the application can provide analytical information regarding foods and beverages purchased or consumed. For example, nutritional information regarding foods consumed can be aggregated and trends, deficiencies or excesses can be identified. In this regard, the user can see, for instance, whether foods consumed comply with various dietary guidelines, whether any critical nutrients are deficient in the user's diet, whether the total amount of food or particular types of food are appropriate given the user's age, gender, weight, lifestyle, etc. Information can be displayed graphically and/or warnings or notifications can be automatically generated and displayed on the connected device or sent text messaging or via-email to the user's e-mail address. In this manner, the application assists the user in eating the right foods in right proportions. For instance, it might advise a user that he/she has reached a recommended daily allowance of sodium or carbohydrates or has not consumed sufficient protein, potassium, fiber, and so forth.

The present invention is intended for home, commercial, or professional use, and can be deployed as a fixed unit in a kitchen, or to support travel, picnics, tailgate parties, school functions, business meeting, catering and all occasions where it is beneficial to provide a broad selection of freshly prepared and well-preserved foods to large and small bodies of people.

The system can be used by individuals, families, restaurants, food service operations, and weight management organizations.

The above disclosure is sufficient to enable one of ordinary skill in the art to practice the invention, and provides the best mode of practicing the invention presently contemplated by the inventor. While there is provided herein a full and complete disclosure of the preferred embodiments of the present invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A food storage and nutrition management system for organizing, separating, storing, preserving, and facilitating the convenient use of a number of separate food items, comprising:
a primary container having an open top, a bottom, and sides which define a volume for storing a plurality of secondary containers smaller than sad primary container;
a plurality of secondary containers, each smaller than said primary container, for storing food items, each of said secondary containers having a bottom side and an upper rim, and sized and configured such that when placed on said bottom of said primary container, said secondary containers have substantially co-planar upper rims defining open ends;
a container lid having a top panel and sides and configured for sealing and enclosing said primary container; and
a resilient and reusable gasket disposed on the underside of said top panel of said container lid, said gasket configured to engage said upper rims of said secondary containers when said lid is sealingly placed on said primary container, such that said gasket is partially compressed and forms a substantially air tight seal between each of said secondary containers.

2. The system of claim 1, wherein said gasket is configured as a grid having substantially identically sized square grid cells, and wherein said plurality of secondary containers includes at least one small secondary container and at least one larger size secondary container, wherein the periphery of said upper rim of each larger size container defines a shape and has an area that is an even multiple of the size and area defined by the periphery of said upper rim of said small secondary container.

3. The system of claim 2, wherein said secondary containers include a small, medium, and large size.

4. The system of claim 2, wherein said gasket is removable.

5. The system of claim 2, wherein said gasket is fabricated from silicone.

6. The system of claim 2, wherein regardless of the arrangement of said secondary containers within said primary container, said gasket seals said secondary containers when said lid is securely placed on said primary container.

7. The system of claim 1, wherein said gasket comprises a compressible foam panel disposed on said underside of said top panel of said lid, and an impermeable plastic sheet disposed on the bottom side of said compressible foam panel.

8. A fresh food management system, comprising:
software for running on a smart phone;
an interactive data base accessible by an Internet connected smart phone; and
a food storage apparatus having a primary container, a plurality of smaller secondary containers, and a lid with a resilient gasket that provides a substantially airtight seal over any secondary containers placed within said primary container.

9. The system of claim 8, wherein said software includes interactive meal planning and shopping list interfaces, and wherein said interactive data base is a data base of dietary and nutritional information.

10. The system of claim 8, wherein said food storage apparatus consisting of a greater container, and smaller containers or compartmental inserts that fit inside the greater container and are of different sizes, and a sealable lid that contacts the edges of the smaller containers to house and preserve prepared food.

11. A method for managing personal nutrition, comprising the steps of:
(a) providing software for running on a smart phone;
(b) loading and running said software;
(c) inputting information regarding food preferences;
(d) providing a database of nutritional information on a server computer accessible by the smart phone over the Internet, said data base including information relating to the food items input in step (c)
(e) comparing the nutritional information obtained in step (d) with one or more dietary guidelines; and
(f) outputting a result of the comparison.

12. The method of claim 11, wherein step (e) takes into account user-specific information relating to one or more characteristics of the user, the characteristics including age, gender, weight, height, health status, and lifestyle.

13. The method of claim 11, wherein the information input at step (c) is entered using either a digital photograph or a scan of food item code.
